(19) United States
(12) Patent Application Publication
(10) Pub. No.: US 2011/0027683 A1
(43) Pub. Date: Feb. 3, 2011

(54) Solid Oxide Fuel Cell Devices With Serpentine Seal Geometry

(76) Inventor: Marcos German Ortiz, Painted Post, NY (US)

Correspondence Address: CORNING INCORPORATED, SP-TI-3-1, CORNING, NY, 14831, US

(21) Appl. No.: 12/671,579

(22) PCT Filed: Aug. 5, 2008
(86) PCT No.: PCT/US08/09414

§ 371 Date: Feb. 1, 2010

Related U.S. Application Data
(60) Provisional application No. 60/963,933, filed on Aug. 8, 2007.

(51) Int. Cl. H01M 8/10; H01M 8/04

(52) U.S. Cl. 429/479; 429/535

(57) ABSTRACT

A fuel cell device assembly comprises: (i) a frame having a support surface; (ii) an electrolyte sheet comprising an electrochemically active area and an electrochemically inactive area, wherein the inactive area comprises a seal area; and (iii) a seal material interposed between and contacting at least a portion of the frame support surface and at least a portion of the electrolyte sheet seal area. The seal material has serpentine geometry.

### STATEMENT REGARDING FEDERALLY SPONSORED RESEARCH FOR DEVELOPMENT

This invention was made with Government support under Cooperative Agreement 70NANB4H3036 awarded by the National Institute of Standards and Technology (NIST). The United States Government may have certain rights in this invention.

### BACKGROUND OF THE INVENTION

1. Field of the Invention

The present invention relates to solid oxide fuel cells and, more specifically, to seal area configurations that can reduce the stress and resulting fractures during operation of solid oxide fuel cell devices.

2. Technical Background

Solid oxide fuel cells (SOFC) have been the subject of considerable research in recent years. Solid oxide fuel cells convert the chemical energy of a fuel, such as hydrogen and/or hydrocarbons, into electricity via electro-chemical oxidation of the fuel at temperatures, for example, of about 700° C. to about 1000° C. A typical SOFC comprises a negatively charged oxygen-ion conducting electrolyte sandwiched between a cathode layer and an anode layer. Molecular oxygen is reduced at the cathode and incorporated in the electrolyte, wherein oxygen ions are transported through the electrolyte to react with, for example, hydrogen at the anode to form water.

The fuel cell devices may include electrode-electrolyte structures comprising a solid electrolyte sheet incorporating a plurality of positive and negative electrodes bonded to opposite sides of a thin flexible inorganic electrolyte sheet. The thin, inorganic sheets that have strength and flexibility to permit bending without fracturing and have excellent temperature stability over a range of fuel cell operating temperatures.

SOFC devices are typically subjected to large thermal-mechanical stresses due to the high operating temperatures and rapid temperature cycling of the device. Such stresses can result in deformation of device components and can adversely impact the operational reliability and lifetime of SOFC devices.

The electrolyte sheet of a SOFC device is typically sealed to a frame support structure in order to keep fuel and oxidant gases separate. In some cases, the thermal mechanical stress and resulting deformation may be concentrated at the interface between the electrolyte sheet and the seal, resulting in a failure of the seal, the electrolyte sheet, and/or the SOFC device. Differential gas pressure and interactions between the device, the seal, and the frame due to temperature gradients and the mismatch of component properties (e.g., thermal expansion and rigidity) may lead to increased stress at the seal and the unsupported region of the electrolyte sheet adjacent to the seal. Large electrolyte sheets are especially subject to failure caused by stress induced fracturing of electrolyte sheet wrinkles, buckling or corrugation. In addition, if the fuel cell device assembly utilizes large rectangular electrolyte sheets, the seal may fail due to cumulative stress along the long section of the seal, due to differences in thermal expansion between the seal, the electrolyte sheet, and electrolyte support frame.

Thus, there is a need to address the thermal mechanical integrity of solid oxide fuel cell seals and electrolyte sheets, and other shortcomings associated with solid oxide fuel cells and methods for fabricating and operating solid oxide fuel cells. These needs and other needs are satisfied by the articles, devices and methods of the present invention.

### SUMMARY OF THE INVENTION

The present invention relates to electrochemical devices comprising ceramic electrolytes and seal structures useful in attaching a thin electrolyte sheet to its support. The present embodiments of the present invention address at least a portion of the problems described above through the use of novel seal structures and novel methods for manufacturing same.

In one embodiment, a fuel cell device assembly comprises: (i) a frame having a support surface; (ii) an electrolyte sheet comprising an electrochemically active area and an electrochemically inactive area, wherein the inactive area comprises a seal area; and (iii) a seal material interposed between and contacting at least a portion of the frame support surface and at least a portion of the electrolyte sheet seal area. The seal material has serpentine geometry.

In another embodiment, the present invention also provides a method for manufacturing a fuel cell device assembly summarized above. For example, the method can generally comprise the steps of providing a frame having a support surface and providing a device comprising an electrolyte sheet. At least a portion of the electrolyte sheet and the frame support surface are connected with a seal material, wherein the seal material has serpentine geometry.

Additional embodiments of the invention will be set forth, in part, in the detailed description, and any claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

The accompanying drawings, which are incorporated in and constitute a part of this specification, illustrate certain embodiments of the instant invention and together with the description, serve to explain, without limitation, the principles of the invention.

FIG. 1 is a schematic illustration of a conventional solid electrochemical device assembly.

FIG. 2 illustrates a finite elemental analysis diagram of the stresses that can occur in the electrolyte sheet of a conventional multi-cell rectangular fuel cell device.

FIG. 3 is a schematic illustration of a conventional fuel cell device, indicating the typical failure locations on a rectangular electrolyte sheet.

FIG. 4 is an illustration of an exemplary serpentine seal geometry pattern utilized in an embodiment of the present invention.

FIG. 5A is a schematic drawing (top view) of an embodiment of a fuel cell device assembly with a serpentine seal geometry pattern.

FIG. 5B is a schematic cross-sectional drawing of the embodiment of FIG. 5A.

FIG. 6 is an illustration of an exemplary embodiment of a fuel cell device assembly of the present invention.

FIG. 7 is another illustration of an exemplary embodiment of a fuel cell device assembly of the present invention.

### DETAILED DESCRIPTION

The present invention can be understood more readily by reference to the following detailed description, drawings, examples, and claims, and their previous and following description. However, before the present compositions, articles, devices, and methods are disclosed and described, it is to be understood that this invention is not limited to the specific compositions, articles, devices, and methods disclosed unless otherwise specified, as such can, of course, vary. It is also to be understood that the terminology used herein is for the purpose of describing particular embodiments only and is not intended to be limiting.

The following description of the invention is provided as an enabling teaching of the invention in its currently known embodiments. To this end, those skilled in the relevant art will recognize and appreciate that many changes can be made to the various embodiments of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative examples of the present invention and not in limitation thereof.

In this specification and in the claims which follow, reference will be made to a number of terms which shall be defined to have the following meanings:

As used herein, the singular forms “a,” “an” and “the” include plural referents unless the context clearly dictates otherwise. Thus, for example, reference to a “component” includes embodiments having two or more such components, unless the context clearly indicates otherwise.

As used herein, a “wt. %” or “weight percent” or “percent by weight” of a component, unless specifically stated to the contrary, refers to the ratio of the weight of the component to the total weight of the composition in which the component is included, expressed as a percentage.

As briefly introduced above, the present invention provides seal structures that can reduce and/or prevent device failure due to thermal mechanical stresses. The proposed methods can lead to improved thermal mechanical integrity and robustness of a solid oxide fuel cell device. Several approaches to improve thermal mechanical integrity of fuel cell components are disclosed herein.

Although the seals structures and methods of the present invention are described below with respect to a solid oxide fuel cell, it should be understood that the same or similar seal structures and methods can be used in other applications where a need exists to seal a ceramic sheet to a support frame. Accordingly, the present invention should not be construed in a limited manner.

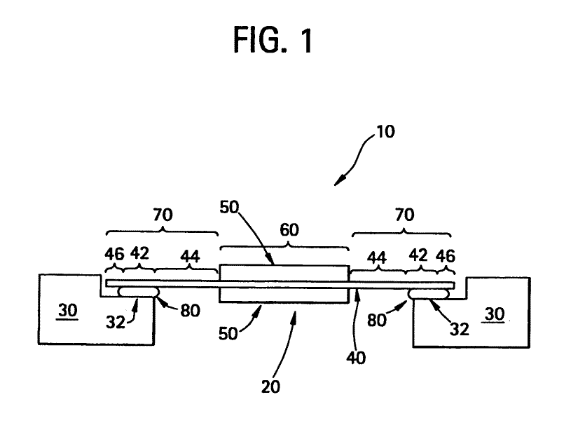

With reference to FIG. 1, a conventional solid oxide fuel cell device assembly 10 is shown, comprising a fuel cell device 20 supported by a frame 30. The fuel cell device is comprised of a ceramic electrolyte sheet 40 sandwiched between at least two electrodes 50, typically at least one anode and at least one cathode. The ceramic electrolyte can comprise any ion-conducting material suitable for use in a solid oxide fuel cell. The electrolyte can comprise a polycrystalline ceramic such as zirconia, yttria, scandia, ceria, or a combination thereof, and can optionally be doped with at least one dopant selected from the group consisting of the oxides of Y, Hf, Ce, Ca, Mg, Sc, Nd, Sm, Eu, Gd, Tb, Dy, Ho, Er, Tm, Yb, Lu, In, Ti, Sn, Nb, Ta, Mo, W, or a mixture thereof. The electrolyte can also comprise other filler and/or processing materials. An exemplary electrolyte is a planar sheet comprised of zirconia doped with yttria, also referred to as yttria stabilized zirconia (YSZ). Solid oxide fuel cell electrolyte materials are commercially available (Ferro Corporation, Penn Yan, New York, USA) and one of skill in the art could readily select an appropriate ceramic electrolyte material.

The fuel cell device is typically connected to the support frame by a seal material 80 disposed between in contact with a top support surface 32 of the frame and a seal portion or area 42 of the electrolyte sheet 40. The seal of a solid oxide fuel cell device assembly can comprise any material suitable for use in sealing an electrolyte and a frame of a solid oxide fuel cell. For example, the seal can comprise a glass frit composition or a metal, such as a foamed metal. A glass frit seal can further comprise ceramic materials and/or coefficient of thermal expansion matching fillers. It is typically preferred that the seal comprise a glass frit.

As shown, the electrodes 50 (comprised of at least one anode and at least one cathode), can be positioned on opposing surfaces of the electrolyte. However, in an alternative arrangement (not shown), a solid oxide fuel cell can comprise a single chamber, wherein both the anode and the cathode are on the same side of the electrolyte. The electrodes can comprise any materials suitable for facilitating the reactions of a solid oxide fuel cell. The anode and cathode can comprise different or similar materials and no limitation to materials or design is intended. The anode and/or cathode can form any geometric pattern suitable for use in a solid oxide fuel cell. The electrodes can be a coating or planar material positioned parallel to and on the surface of the ceramic electrolyte. The electrodes can also be arranged in a pattern comprising multiple independent electrodes. For example, an anode can be a single, continuous coating on one side of an electrolyte or a plurality of individual elements, such as strips, positioned in a pattern or array.

An anode can comprise, for example, yttria, zirconia, nickel, or a combination thereof. An exemplary anode can comprise a cermet comprising nickel and the electrolyte material such as, for example, zirconia.

A cathode can comprise, for example, yttria, zirconia, manganate, ferrate, cobaltate, or a combination thereof. Exemplary cathode materials can include, yttria stabilized zirconia, lanthanum strontium manganate, lanthanum strontium ferrate, and combinations thereof.

The area of the electrolyte sheet on which the electrodes are positioned is referred to as the active area 60 of the electrolyte sheet. The remaining outer surface portions 70 of the electrolyte sheet are referred to as the inactive surface areas or portions of the electrolyte sheet. These inactive surface area portions comprise the seal area 42 described above, and an optional streetwidth 44 (which refers to the portion between the active area and the seal area of an electrolyte sheet), and an overhanging portion 46.

During fuel cell operation, the electrolyte, frame, and seal can be subjected to operating temperatures of from about 600° C. to about 1,000° C. In addition, fuel cell device components, the frame, and the seal can experience rapid temperature cycling during, for example, startup and shutdown cycles. The thermal mechanical stresses placed on these components and the seal under such conditions can result in significant stress occurring in the seal region. Such stresses can arise from a number of sources but are typically the result of local self corrugation due to local CTE differences and bending and out of plane deformation of the fuel cell device caused by global CTE difference between the frame and the fuel cell device. Such stresses can also occur if there are temperature gradients between different areas in the fuel cell device assembly, such as when the device is hotter in some regions than the frame. Such situations are also likely to occur during start up or cool down of a fuel cell stack or a fuel cell device assembly or even during transient conditions where the power output of the device is changing. These stresses can result in subsequent deformation, fracture, or even total failure of the components or the entire fuel cell device assembly.

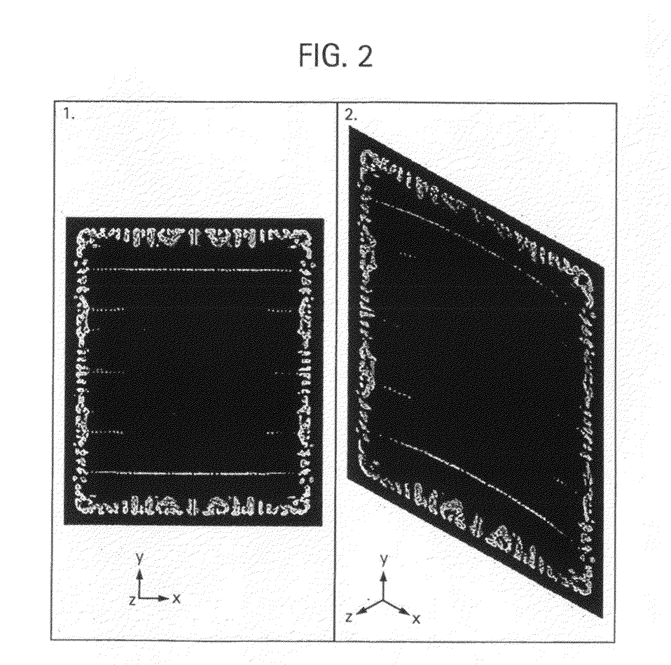

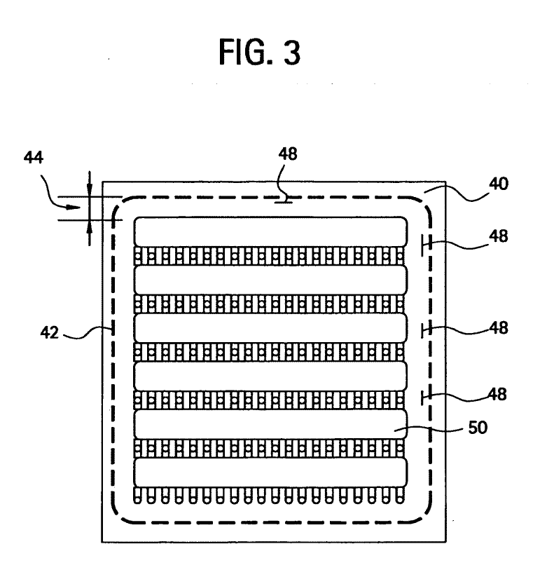

The existence of such stresses 47 can be shown, for example, in FIG. 2, which provides a modeled finite element analysis (FEA) for an exemplary fuel cell device “at or near the seal region. The seal region, where the electrolyte sheet and the frame are forced to be together, exhibits a high frequency pattern of stress perpendicular to the seal. The rest of the electrolyte sheet bows out of the plane and the transition region adjacent to the seal area has maximum stresses, parallel to the seal. The FEA analysis was conducted under the assumption that the seal geometry is a planar rectangle with slightly rounded corners (for example, indicated by the dash lines in FIG. 3). The electrolyte sheet was modeled with the appropriate E-modulus and thermal expansion coefficient associated with zirconia based electrolyte sheet (3 mole % yttria stabilized zirconia). The electrodes and via pads were modeled based upon the assumption that they had the thermal expansion and modulus characteristics of gold. The device was assumed to be stress free at room temperature and in the model the temperature was raised to 725° C. Still further, the metal electrodes were assumed to be elastic such that no plastic deformation was allowed. As shown by the shading gradients, the CTE difference stresses are concentrated in the thin electrolyte at or near the seals.

When solid oxide fuel cell devices (thin electrolyte, multi-cell devices) crack, they typically fracture along the high stressed regions identified in FIG. 2, near or at the seal region, away from the electrodes and vias. FIG. 3 illustrates a schematic diagram of typical fracture sites 48 in the electrolyte sheet 40 of a solid oxide fuel cell device when the seal material is not applies in a serpentine fashion. The exemplified fuel cell device is representative of a device having a “street width” 44 in the range of about 5 mm-to about 10 mm between the electrodes 50 and the seal area 42.

The embodiments of the present invention minimize unwanted seal failure, minimize stress at or near seal area, and minimize electrolyte sheet deformation, fracture, and/or failure. To address the occurrence of stress and the resulting fractures that can occur, the present invention provides solid oxide fuel cell device assemblies having novel seal area configurations wherein seal has serpentine geometry. By applying the seal material in a serpentine pattern the likelihood of any cracks forming in the typically high stress regions of the electrolyte sheet is minimized or eliminated.

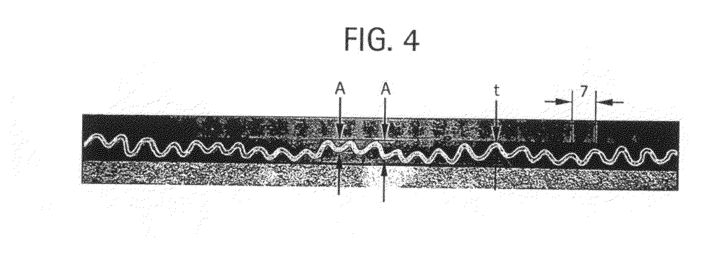

According to the exemplary embodiments, when the seal material 80 is applied such that it forms a serpentine pattern), the seal is less likely to fail, and/or the cracks at or near the seals can be advantageously eliminated. The serpentine pattern may be regular or irregular. That is, the “squiggles” may have slightly different amplitudes, width or length. An exemplary serpentine pattern made of glass-ceramic seal paste is shown in FIG. 4. This pattern was produced by a manual paste application. However the seal material may also be applied automatically, and will result in a more regular pattern. The pencil marks shown in FIG. 4 are 5 mm apart.

More specifically, it is preferred that the serpentine pattern has (i) thickness t of less than about 0.003 m (not greater than 3 mm), preferably between 0.0005 m and 0.002 m; (ii) amplitude A of less than 0.02 m, preferably less than 0.01 m, and even more preferably less than 0.008 m; and (iii) average wavelength λ (distance between two heights) of less than 0.2 m. More preferably thickness t is less than 0.001 m; (ii) amplitude A of less than 0.005 m (e.g., 2, 3 or 4 mm); and (iii) average wavelength λ (distance between two heights) of less than 0.1 m. The seal is therefore configured of short, alternating, relatively straight portions that by virtue of their short length limit the local thermal expansion differential between the electrolyte sheet and the frame (as it is proportional to their length, or the amplitude A). The serpentine pattern allows these short sections alternate in direction, forcing a pre-determined buckling pattern on the electrolyte sheet to absorb and distribute the overall thermal expansion differential experienced by the entire seal. The buckling pattern keeps the stresses below the rupture limit of the membrane material. The shape also allows the hard seal to absorb its own thermal expansion differential with the frame in a distributed managed fashion. The exemplary pattern of FIG. 4 has a wavelength of about 5 mm, an amplitude A that varies between about 2 mm and about 6 mm, and thickness t of about 1 mm.

The seals are typically formed of a glass or glass ceramic material 80 that can be sintered to zero open porosity in the temperature range of above 750° C. and below 1000° C. and are typically of lower expansion than the frame or the device. The frames to which the electrolyte sheet is bonded are typically made of stainless steel such as 430 and 446 and have a slightly higher expansion than the fuel cell device. This puts the fuel cell devices into compression when cooling from the seal sintering temperature and causes the device sometimes to bow out of plane.

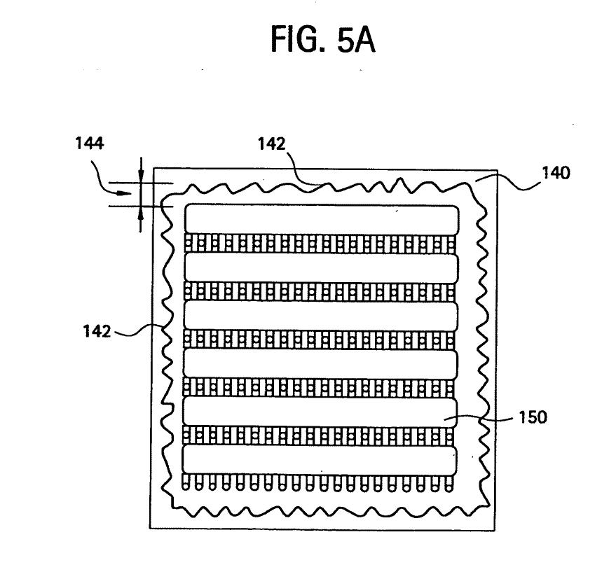

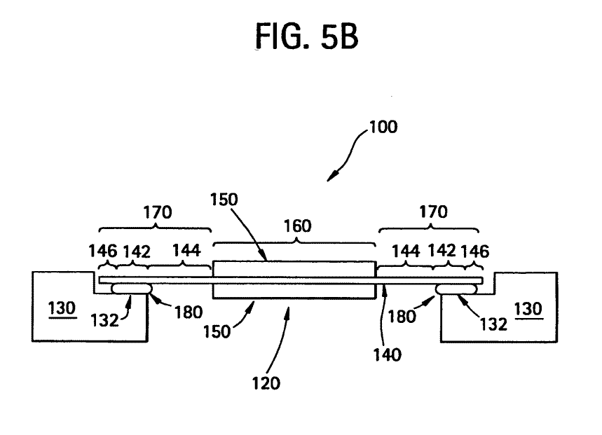

With reference to FIGS. 5A (top view) and 5B (cross-section), an exemplary fuel cell device assembly 100 of the present invention is shown. The device assembly comprises a fuel cell device 10 supported by a frame 130. The fuel cell device 120 is comprised of a ceramic electrolyte sheet 140 sandwiched between two electrodes 150, shown as at leas t one anode 152 and a cathode 154. The electrolyte sheet 140 is further comprised of an inner active area 160 upon which the electrodes are in contact, and also comprising an outer inactive area 170. The outer inactive area of the electrolyte sheet comprises a seal area 142.

The frame 130 (not shown) has a top support surface 132 and a generally planar bottom surface 134. The electrolyte sheet 140 is sealed to a frame 130 by a seal material 180. More specifically, a ceramic bonding material or seal material 180 is interposed between at least a portion of the frame support surface 132 and the seal area 142 of the electrolyte sheet. As shown, the seal material 180 has serpentine geometry/pattern.

The present invention further provides methods for manufacturing the electrochemical device assemblies, and solid oxide fuel cell devices, comprising each of the seal structure embodiments recited herein for reducing and/or eliminating deformation and failure of fuel cell components, either individually or in various combinations. Accordingly, the methods of the present invention generally comprise providing a frame as described herein, having a support surface. A fuel cell device comprising an electrolyte sheet as described herein can be provided. At least a portion of the electrolyte sheet is connected to at least a portion of the frame support surface with a seal material, such that the portion of the seal formed by the seal material has smooth serpentine geometry. To that end, in one embodiment, the seal material 80 as described herein can be first applied in serpentine fashion to the support surface of the frame and then subsequently contacted with the electrolyte sheet. Alternatively, the step of connecting at least a portion of the electrolyte sheet to at least a portion of the frame support surface can first comprise applying the seal material in a serpentine fashion to the ceramic electrolyte sheet and then contacting the applied seal material with the frame support surface.

### Examples

To further illustrate the principles of the present invention, the following examples are put forth so as to provide those of ordinary skill in the art with a complete disclosure and description of how the solid oxide fuel cell devices claimed herein can be made and evaluated. They are intended to be purely exemplary of the invention and are not intended to limit the scope of what the inventors regard as their invention. Efforts have been made to ensure accuracy with respect to numbers (e.g., amounts, temperatures, etc.); however, some errors and deviations may have occurred. Unless indicated otherwise, parts are parts by weight, temperature is ° C. or is at ambient temperature, and pressure is at or near atmospheric.

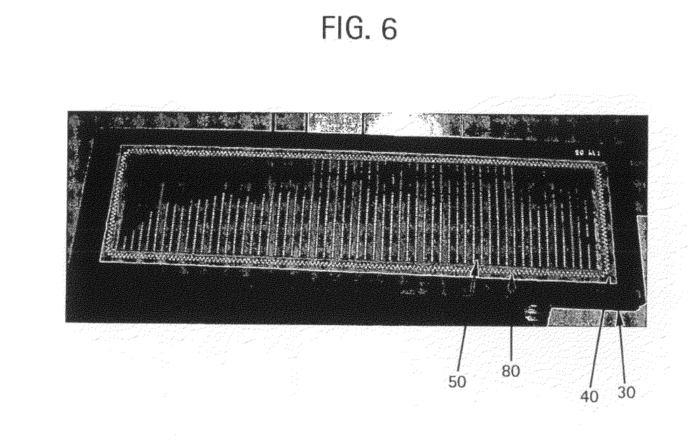

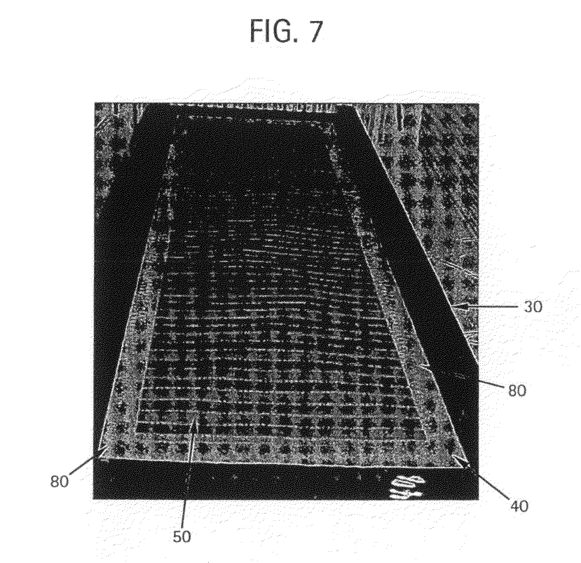

For the following examples (see FIG. 6, 7), rectangular frame 30 was machined from 446 Stainless Steel. The seal paste 80 was applied in a serpentine (sinusoidal) pattern. Electrolyte sheet was manufactured from a composition 3 mole % yttria stabilized zirconia further comprising very minor alumina and silica impurities. The electrolyte sheet was approximately 20 microns thick. The electrolyte supported 59 pairs of electrodes, electrically interconnected through the electrolyte sheet by via interconnects. The electrolyte sheet was bonded to the frame using a glass/ceramic seal material comprised of the glass and ceramic particles along with binders and solvents and having a thermal expansion coefficient lower than the electrolyte. A thin line of the seal material (glass frit) paste approximately 1-3 mm thick was laid down on the steel frame and allowed to at least partially harden by driving off some of the solvent at slightly elevated temperature (about 100° C. for about 1 hour). The electrolyte sheet was then placed on the seal material. The assembly was then heated at a temperature in the range of 700° C.-1000° C. and the seal was formed by sintering under light pressure for several hours. FIGS. 6 and 7 and illustrate a fuel cell device assembly made according to the procedure described above. These figures also show buckling and/or bow out of the electrolyte sheet resulting from thermo mechanical stresses at room temperature, caused by differential CTE between the electrolyte sheet and the frame.

It is to be understood that various modifications and variations can be made to the compositions, articles, devices, and methods described herein. Other embodiments of the compositions, articles, devices, and methods described herein will be apparent from consideration of the specification and practice of the compositions, articles, devices, and methods disclosed herein. It is intended that the specification and examples be considered as exemplary. Thus, it is intended that the present invention cover the modifications and variations of this invention provided they come within the scope of the appended claims and their equivalents.

1. A fuel cell device assembly, comprising:
a frame having a support surface;
an electrolyte sheet comprising an electrochemically active area and an electrochemically inactive area, wherein the inactive area comprises a seal area; and
a seal material interposed between and contacting at least a portion of the frame support surface and at least a portion of the electrolyte sheet seal area;
wherein said seal material has serpentine geometry.

2. The fuel cell device assembly of claim 1, wherein said serpentine geometry is characterized by pattern that (i) is less than 0.003 m thick, (ii) has an amplitude of less than 0.01 m, and (iii) has an average wavelength λ, where 0.005 m<λ<0.2 m.

3. The fuel cell device assembly of claim 1, wherein said serpentine geometry is characterized by a sinusoidal pattern.

4. The fuel cell device assembly of claim 1, wherein the frame is rectangular.

5. The fuel cell device assembly of claim 1, wherein the active region of the electrolyte sheet is substantially planar.

6. The fuel cell device assembly of claim 1, wherein the active region of the electrolyte sheet is substantially non-planar.

7. A method for manufacturing an electrochemical device assembly; comprising:
providing a frame having a top support surface and a planar bottom surface;
providing a device comprising an electrolyte sheet; and
connecting at least a portion of the electrolyte sheet to at least a portion of the frame top support surface with a seal material, wherein said seal material has serpentine geometry.

8. The method of claim 7, wherein the step of connecting at least a portion of the electrolyte sheet to at least a portion of the frame top support surface comprises first applying the seal material to the ceramic electrolyte sheet; and then contacting the applied seal material with the frame top support surface.

9. The method of claim 7, further comprising the step of sintering said seal material.

10. A fuel cell device assembly, comprising:
a frame having a support surface;
an electrolyte sheet comprising an electrochemically active area and an electrochemically inactive area, wherein the inactive area comprises a seal area; and
a seal interposed between and contacting at least a portion of the frame support surface and at least a portion of the electrolyte sheet seal area;
wherein said seal is situated in serpentine pattern with a pattern: (i) thickness between 0.0005 m and 0.002 m; (ii) amplitude of less than 0.02 m; and (iii) average wavelength of less than 0.2 m.
